(19) United States
(12) Patent Application Publication
(10) Pub. No.: US 2019/0107105 A1
(43) Pub. Date: Apr. 11, 2019

(54) Linear Drive Beam Pumping Unit

(71) Applicant: Lufkin Industries, LLC, Lufkin, TX (US)

(72) Inventor: David Warren Doyle, Groveton, TX (US)

(73) Assignee: Lufkin Industries, LLC, Lufkin, TX (US)

(21) Appl. No.: 16/155,403

(22) Filed: Oct. 9, 2018

Related U.S. Application Data
(60) Provisional application No. 62/570,633, filed on Oct. 10, 2017.

(51) Int. Cl. F04B 17/03; H02K 33/06; F04B 47/14; F04B 9/105

(52) U.S. Cl. CPC F04B 17/03; F04B 9/105; F04B 47/145; H02K 33/06

(57) ABSTRACT

A beam pumping unit includes a base, a Sampson post supported by the base, a walking beam pivotably supported by the Sampson post and a horsehead on the front end of the walking beam. The horsehead is connected to a polished rod that extends through a wellhead to a subsurface pump. The beam pumping unit includes a linear drive unit connected between the base and the Sampson post to force the walking beam to rock up and down on the Sampson post. The linear drive unit includes a linear drive system and an integrated pneumatic counterbalance system.

### RELATED APPLICATIONS

The present application claims the benefit of U.S. Provisional Patent Application Ser. No. 62/570,633 entitled “Linear Drive Beam Pumping Unit,” filed Oct. 10, 2017, the disclosure of which is herein incorporated by reference.

### FIELD OF THE INVENTION

This invention relates generally to oilfield equipment, and in particular to surface-mounted reciprocating-beam pumping units, and more particularly, but not by way of limitation, to a beam pumping unit driven by a linear drive unit.

### BACKGROUND

Hydrocarbons are often produced from well bores by reciprocating downhole pumps that are driven from the surface by pumping units. A pumping unit is connected to its downhole pump by a rod string. Although several types of pumping units for reciprocating rod strings are known in the art, walking beam style pumps enjoy predominant use due to their simplicity and low maintenance requirements.

A conventional walking beam pump jack operates, in essence, as a simple kinematic four-bar linkage mechanism, in which each of four rigid links is pivotally connected to two other of the four links to form a closed polygon. In a four-bar linkage mechanism, one link is typically fixed, with the result that a known position of only one other body is determinative of all other positions in the mechanism. The fixed link is also known as the ground link. The two links connected to the ground link are referred to as grounded links, and the remaining link not directly connected to the fixed ground link is referred to as the coupler link. Four-bar linkages are well known in mechanical engineering disciplines and are used to create a wide variety of motions with just a few simple parts.

Beam pumping units and their upstream drive components are exposed to a wide range of loading conditions. These vary by well application, the type and proportions of the pumping unit's linkage mechanism, and counterbalance matching. The primary function of the pumping unit is to convert rotating motion from the prime mover (engine or electric motor) into reciprocating motion above the wellhead. This motion is in turn used to drive a reciprocating down-hole pump via connection through a sucker rod string.

Referring to FIG. 1, a four-bar linkage is embodied in the design of a prior art pump jack (10) as follows. A fixed link (Link K) extends from the centerline of the crankshaft (12) to the centerline of the center bearing (15). Link K is defined by a grounded frame formed of interconnected rigid bodies including the Sampson post (13), the base (11), the gearbox pedestal (17), and the reducer gearbox (16). The first grounded link (Link R) is defined by the crank arms (20), and the second grounded link (Link C) is defined by the rear portion of the walking beam (24) extending from the centerline of the center bearing (15) to the centerline of the equalizer bearing (25). The equalizer bearing (25), pitmans (26) and the equalizer (27) together define the coupler link (Link P). This four-bar linkage is dimensioned so as to convert rotational motion of Link R into pivotal oscillation of Link C via the coupler Link P and the fixed Link K. That is, the crank arms (20) seesaw the walking beam (24) about the center bearing (15) atop the Sampson post (13) via the pitman arms (26) and equalizer (27).

The “4-bar linkage” comprising the articulating beam, pitman, cranks, and connecting bearings processes the load from the polished rod into one component of the gear box torque (well torque). The other component, counterbalance torque, is adjusted on the pumping unit to yield the lowest net torque on the gearbox. Counterbalance torque can be adjusted in magnitude but typically not in phase (timing) with respect to the well load torque. In crank balanced machines, counterbalance torque will appear sinusoidal as it is effectively a mass being acted on by gravity while rotating about a fixed horizontal axis.

Counterbalance may be provided in a number of forms ranging from beam-mounted counterweights, to crank-mounted counterweights (as shown in FIG. 1), to compressed gas springs mounted between the walking beam and base structure to name only a few. The primary goal in incorporating counterbalance is to offset a portion of the well load approximately equal to the average of the peak and minimum polished rod loads encountered in the pumping cycle. This technique typically minimizes the torque and forces at work on upstream driveline components reducing their load capacity requirements and maximizing energy efficiency.

Although generally effective at offsetting a portion of the load produced by the downhole components of the reciprocating pumping system, the rotating mass of the crank-mounted counterweights are difficult to rapidly adjust under advanced control schemes. The elasticity of the sucker rod string may present an oscillatory response when exposed to variable loads. The motion profile of the driving pumping unit combined with the step function loading of the pump generally leaves little time for the oscillations to decay before the next perturbation is encountered. The flywheel effect produced by massive rotating components within the pumping unit resists rapid changes in speed. Attempts to substantially alter speed within the pumping cycle have generally consumed disproportionately more power which negatively affects operating cost.

In addition to the restrictions placed on the speed and velocity profiles of beam pumping units driven by a rotating mass system, prior art beam pumping units also present a challenge when adjusting the length of the stroke. Changing stroke length in these prior art pumping systems is a manual process that includes decoupling the pumping unit from the well load and making adjustments to the geometry of the pumping unit. These adjustments cannot be made in real time during operation of the pumping unit and often require hours or days of downtime.

There is, therefore, a need for an improved beam pumping unit that can be more effectively controlled and adjusted in real time to accommodate changes in the downhole environment and stresses that propagate throughout the beam pumping unit system. It is to these and other deficiencies in the prior art that the present embodiments are directed.

### SUMMARY OF THE INVENTION

In an exemplary embodiment, the present invention includes a beam pumping unit configured to raise and lower a polished rod. The beam pumping unit has a base, a Sampson post supported by the base and a walking beam pivotably supported by the Sampson post. The beam pumping unit includes a horsehead on the front end of the walking beam that is connected to the polished rod. The beam pumping unit further includes a linear drive unit connected between the base and the walking beam to control the rocking motion of the walking beam. The linear drive unit includes a linear drive system and an integrated counterbalance system.

In another embodiment, the present invention includes a beam pumping unit configured to raise and lower a polished rod, where the beam pumping unit has a base, a Sampson post supported by the base, a walking beam pivotably supported by the Sampson post and a horsehead on the front end of the walking beam. The horsehead is connected to the polished rod. The beam pumping unit further includes a linear drive unit connected between the base and the walking beam. The linear drive unit has a linear drive system that includes a ram and an upper pivot bearing connected between the ram and the walking beam.

In yet another embodiment, the present invention includes a beam pumping unit configured to raise and lower a polished rod, where the beam pumping unit has a base and a Sampson post supported by the base. The Sampson post includes a rear bearing assembly. A walking beam is supported by the Sampson post at the rear bearing assembly and the walking beam includes a horsehead on the front end of the walking beam. The horsehead is connected to the polished rod. The beam pumping unit has a linear drive unit supported by the base and connected to a point on the walking beam between the horsehead and the rear bearing assembly. The linear drive unit has a linear drive system, which in turn includes a motor, a threaded shaft controllably rotated by the motor, a ram and a planetary roller nut connected to the ram and to the threaded shaft. The planetary roller nut is configured such that rotation of the threaded shaft causes the planetary roller nut and ram to move axially. The linear drive unit further includes a pneumatic counterbalance system that applies a pneumatic pressure to the ram to offset a portion of the weight of the polished rod.

### BRIEF DESCRIPTION OF THE DRAWINGS

FIG. 1 is a side view of a PRIOR ART beam pumping unit.

FIG. 2 is a side view of a beam pumping unit with a linear drive unit.

FIG. 3 is a side view of the beam pumping unit of FIG. 2 at the bottom of a pump stroke.

FIG. 4 is a side view of the beam pumping unit of FIG. 2 at the top of a pump stroke.

FIG. 5 is a cross-sectional view of the linear drive unit of the beam pumping unit of FIG. 2.

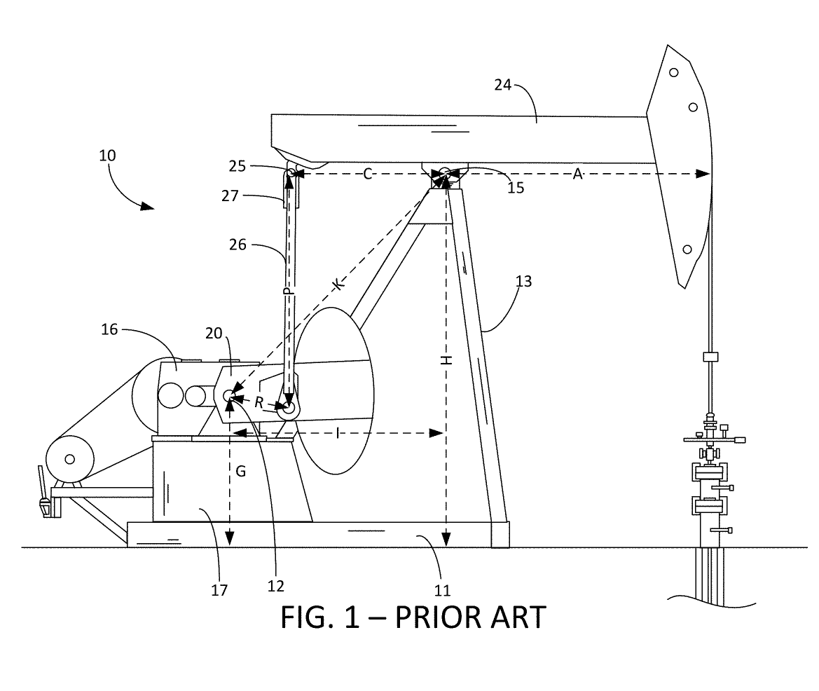

### WRITTEN DESCRIPTION

The figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

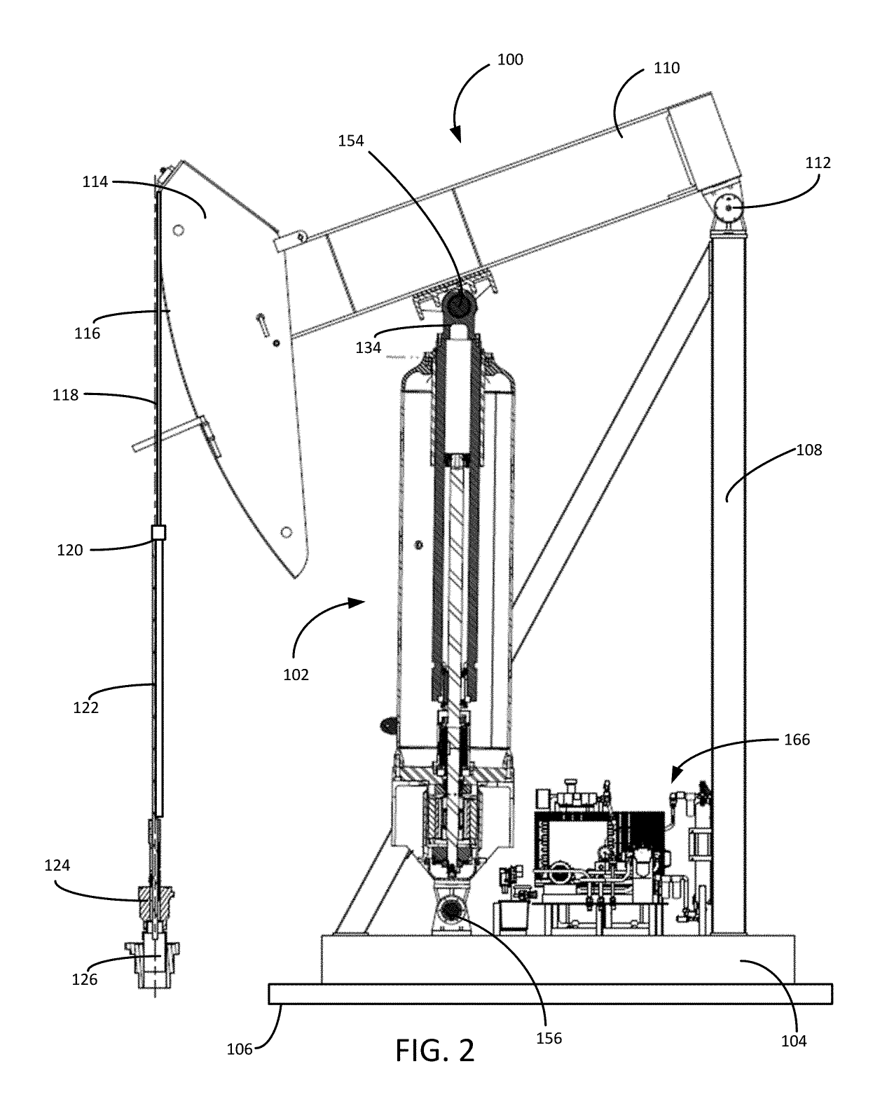

FIGS. 2-4 show a beam pumping unit 100 constructed in accordance with an exemplary embodiment of the present invention. The beam pumping unit 100 includes a linear drive unit 102 and a base 104 that rests on a footing 106. In some embodiments, the base 104 and footing 106 are provided as a single, integral component. The base 104 supports a Sampson post 108. The top of the Sampson post 108 acts as a fulcrum that pivotally supports a walking beam 110 via a rear bearing assembly 112. On the opposite end from the rear bearing assembly 112, the walking beam 110 includes a horsehead 114. The horsehead 114 has an arcuate forward face 116, which interfaces with a flexible wire rope bridle 118. At its lower end, the bridle 118 terminates with a carrier bar 120, upon which a polished rod 122 is suspended. The polished rod 122 extends through a packing gland or stuffing box 124 on a wellhead 126.

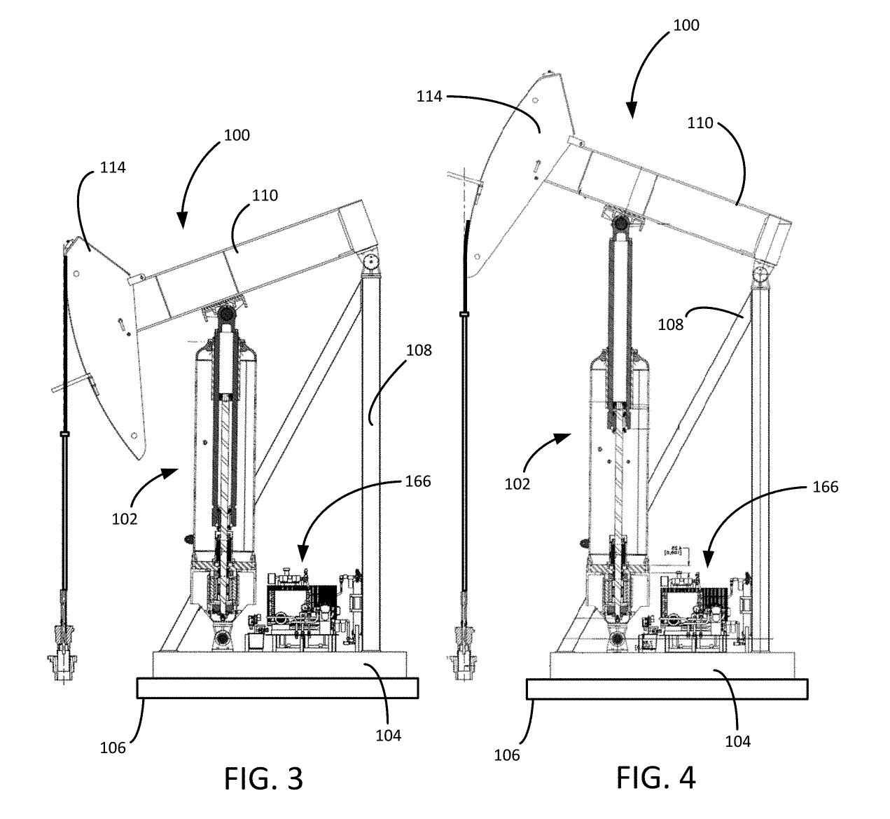

As is generally known in the art, a rod string of sucker rods hangs from the polished rod 122 within a tubing string located within a well casing. The rod string is connected to the plunger of a subsurface pump. In a reciprocating cycle of the beam pumping unit 100, well fluids fill the subsurface pump at the bottom of the pump stroke are lifted within the tubing string during the rod string upstroke. In this way, the beam pumping unit 100 causes the subsurface pump to reciprocate between the bottom of a pump stroke (as depicted in FIG. 3) and the top of a pump stroke (as depicted in FIG. 4) to lift fluids from the well. Unlike prior art beam pumping units, the beam pumping unit 100 does not rely on a rotating crank and 4-bar linkage to produce the rocking motion of the walking beam 110. Instead, the linear drive unit 102 induces and controls the pivotal, reciprocating motion of the walking beam 110.

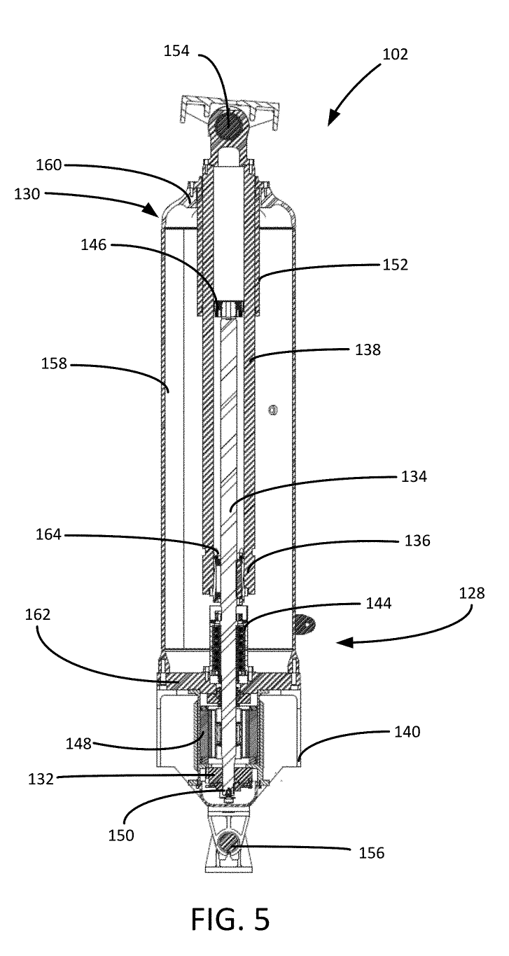

Turning to FIG. 5, shown therein is a cross sectional view of the linear drive unit 102. The linear drive unit 102 includes a linear drive system 128 and a counterbalance system 130. The linear drive system 128 includes a motor 132, a shaft screw 134, a planetary roller nut 136 and a ram 138. The motor 132 is contained within a motor housing 140. In exemplary embodiments, the motor 132 is a permanent magnet electric motor that is driven by a variable speed drive 142 (not shown). A servo controller can be incorporated within the variable speed drive 142 to adjust the operational characteristics of the motor 132. If used in conjunction with supervisory control and data acquisition (SCADA) technology, the linear drive system 128 can be monitored and controlled remotely making it possible to identify and respond to potential equipment maintenance issues or change production goals from a remote control center. The shaft screw 134 is keyed or otherwise fixed to the rotating elements of the motor 132 such that the application of electrical current to the motor 132 causes the shaft screw 134 to rotate at a desired speed. Although the incorporation of the linear drive unit 102 within the beam pumping unit 100 presents a new application of the linear drive unit 102, the linear drive unit 102 is similar in form and function to the linear actuators and counterbalances disclosed in U.S. Pat. No. 9,115,574, the disclosure of which is herein incorporated by reference.

The shaft screw 134 extends through a thrust bearing assembly 144 into the interior of the ram 138. The thrust bearing 144 supports the longitudinal thrust carried along the shaft screw 134 to protect the motor 132. The upper end of the shaft screw 134 is supported by a centralizer bearing 146 that is also positioned inside the ram 138. The lower end of the shaft screw 134 passes through the motor 132 and a shaft brake 148. The shaft brake 148 can be deployed under fail-safe conditions to stop the shaft screw 134 from rotating. In exemplary embodiments, the shaft brake 148 is a spring-loaded magnetic brake in which an electromagnet holds the brake open against the force of a closing spring while power is supplied to the linear drive unit 102. If the linear drive unit 102 loses power, the electromagnet releases and the brake spring forces the shaft brake 148 to engage the shaft screw 134 to stop the rotation of the shaft screw 134. In some embodiments, the shaft brake 148 is positioned above the motor 132 such that the shaft brake 148 can be engaged to permit the motor 132 to be disengaged from the shaft screw 148. An encoder 150 placed adjacent to the shaft 134 detects the rotational position and rotational speed of the shaft 134 and provides that information to the variable speed drive 142 or to a servo controller within the variable speed drive 142.

The roller nut 136 is connected to the lower end of the ram 138. The portion of the shaft screw 134 that extends through the roller nut 136 includes a series of threads that engage with mating threads on the roller nut 136. As the shaft screw 134 rotates within the roller nut 136, the roller nut 136 is forced upward or downward depending on whether the shaft screw 134 is rotating in a clockwise or counterclockwise direction. The resulting vertical displacement of the roller nut 136 causes the ram 138 to move upward or downward within a guide tube 152. Thus, the roller nut 136 and ram 138 are moved by the selective rotation of the shaft screw 134 from a retracted position (shown in FIG. 3) to a deployed position (shown in FIG. 4).

The upper end of the ram 138 is attached to the walking beam 110 with an upper pivot bearing 154. In the exemplary embodiments depicted in FIGS. 2-4, the upper pivot bearing 154 is located at about the midpoint of the walking beam 110. In this position, the vertical movement of the ram 138 is multiplied by the length of the walking beam 110 beyond the upper pivot point. The placement of the upper pivot bearing 154 on the walking beam 110 can be adjusted to increase or decrease ratio of the vertical movement of the arcuate forward face 116 of the horsehead 114 to the vertical movement of the upper end of the ram 138. The vertical movement ratio is inversely proportional to the lift ratio, which relates to the mechanical advantage or disadvantage produced by the lever system of the walking beam 110 and linear drive unit 102.

The linear drive unit 102 is connected to the base 104 with a lower pivot bearing 156 that allows the linear drive unit 102 to articulate with respect to the base 104 while remaining in the same vertical plane as the walking beam 110. The lower pivot bearing 156 may be integrated into the Sampson post 108. As illustrated in the embodiments depicted in FIGS. 3 and 4, the linear drive unit 102 is permitted to rotate back slightly as the ram 138 is fully deployed and rotate forward slightly as the ram 138 is retracted. In exemplary embodiments, the linear drive unit 102 is connected to the base 104 and walking beam 110 such that the linear drive unit 102 is substantially vertical when the walking beam 110 is substantially horizontal.

The counterbalance system 130 includes a pressure jacket 158 that surrounds the guide tube 152. The pressure jacket 158 includes an upper bulkhead 160 and a lower bulkhead 162. Pressurized fluid inside the pressure jacket 158 is communicated into the guide tube 152 below the lower end of the ram 138 through ports 164. A compressor 166 can be used to increase the pressure within the pressure jacket 158. A solenoid-driven bleeder valve can be used to selectively decrease the pressure within the system. The lower end of the ram 138 is slightly enlarged and placed in contact with the interior wall of the guide tube 152. A series of seals (not separately designated) traps the pressurized fluid within the guide tube 152 and the ram 138. In some embodiments, the pressurized fluid is permitted to travel up through the ram 138 through the roller nut 136 and centralizer bearing 146. Although the counterbalance system 130 is presently designed as a pneumatic system in which air is used as the pressurized fluid, it will be appreciated that hydraulic and mixed-fluid systems may also be used to provide a counterbalance effect.

Pressurized fluid entering the guide tube 152 applies an upward force against the lower end of the ram 138 and roller nut 136. The upward force applied by the counterbalance system 130 can be adjusted by controlling the pressure within the pressure jacket 158. In some embodiments, the upward force is actively monitored and adjusted in real time to offset a portion of the weight of the rod string, walking beam 110 and other components of the beam pumping unit 100. The counterbalance effect produced by the counterbalance system 130 can be adjusted so that the counterbalance system 130 operates in an underbalanced, neutral (balanced) or overbalanced condition. The counterbalance system 130 assists the linear drive system 128 in lifting the walking beam 110 and also acts as a damper to prevent uncontrolled downward motion of the walking beam 110 that might otherwise damage the linear drive system 128.

The novel application of the linear drive unit 102 to the beam pumping unit 100 presents a number of advantages over conventional drive and counterbalance systems. In particular, the stroke length, stroke cycle rate and intra-cycle stroke velocities can be rapidly and accurately adjusted in real time in response to feedback from the wellbore to optimize production and reduce wear to subsurface components and the beam pumping unit 100. In one aspect, the stroke length is automatically adjusted in real time to prevent repetitive contact, or “tagging” between the traveling and stationary components of the subsurface pump. In another aspect, the stroke speed is automatically adjusted in real time in response to the detection of “fluid pound,” where the traveling components of the subsurface pump contact the top of the fluid column at a high rate of speed. Similarly, the stroke length can be automatically adjusted to mitigate gas interference problems by placing the traveling components of the subsurface pump very close to the stationary components of the subsurface pump to expel gas accumulating within the subsurface pump between strokes.

In another aspect, the linear drive unit 102 is used to perform leak-down tests on the standing and traveling valves of the subsurface pump. The linear drive unit 102 can be stopped at various points in the stroke cycle to evaluate the effectiveness of the standing valve (during a down stroke) or traveling valve (during an up stroke). In certain applications, the linear drive unit 102 is configured to adjust the intra-cycle stroke velocities to mitigate harmonic stress waves propagating through the rod string. Mitigating harmonic stress waves allows the beam pumping unit 100 to operate under more aggressive pump performance profiles without damaging the beam pumping unit 100 or subsurface components.

In addition to the benefits realized by the operational control of the linear drive unit 102, the beam pumping unit 100 also provides enhanced access to the wellhead 126 for maintenance operations. Prior art linear drive systems, like those disclosed in U.S. Pat. No. 9,115,574, require the placement of lift equipment in close proximity to the wellhead. This may frustrate efforts to gain access to the wellhead for workover or other maintenance operations. The combined use of the walking beam 110 and linear drive unit 102 in the beam pump unit 100 overcomes these deficiencies by providing an offset between the beam pumping unit 100 and wellhead 126. Additionally, because the linear drive unit 102 is captured between the base 104 and the walking beam 110, there is no need for an additional component to prevent the linear drive unit 102 from rotating during use. The base 104 and walking beam 110 prevent the ram 138 from rotating in response to the rotation of the shaft/screw 134.

Although the beam pumping unit 100 is depicted with the walking beam 110 connected to the Sampson post 108 at the rear bearing assembly 112, it will be appreciated that in other embodiments, the middle portion of the walking beam 110 is pivotally supported by the Sampson post 108. In these alternate embodiments, the linear drive unit 102 is positioned behind the Sampson post 108 and placed in an inverted position such that the counterbalance system 130 opposes the upward movement of the rear portion of the walking beam 110 and the linear drive system 128 is configured to pull the rear portion of the walking beam 110 downward during an up stroke of the subsurface pump.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A beam pumping unit configured to raise and lower a polished rod, the beam pumping unit comprising:
a base;
a Sampson post supported by the base;
a walking beam pivotably supported by the Sampson post;
a horsehead on the front end of the walking beam, wherein the horsehead is connected to the polished rod with a wire rope; and
a linear drive unit connected between the base and the walking beam, wherein the linear drive unit comprises:
a linear drive system; and
a counterbalance system.

2. The beam pumping unit of claim 1, wherein the linear drive system comprises:
a motor;
a threaded shaft rotated by the motor;
a ram; and
a planetary roller nut connected to the ram and to the threaded shaft such that rotation of the threaded shaft causes the planetary roller nut and ram to move axially.

3. The beam pumping unit of claim 2, wherein the linear drive system further comprises a guide tube and wherein the ram reciprocates within the guide tube.

4. The beam pumping unit of claim 3, wherein the counterbalance system comprises:
a pressure jacket; and
a path of communication between the ram interior and the pressure jacket.

5. The beam pumping unit of claim 4, wherein the counterbalance system further comprises a compressor connected to the pressure jacket that maintains the pressure of the fluid within the pressure jacket.

6. The beam pumping unit of claim 2, wherein the motor is a permanent magnet electric motor.

7. The beam pumping unit of claim 6, wherein the motor further comprises:
an encoder that is configured to measure the rotational speed and position of the shaft/screw and output representative measurement signals; and
a variable speed drive that controls the operational parameters of the motor, wherein the variable speed drive includes a servo controller that adjusts the operation of the motor in response to measurements signals sent from the encoder to the servo controller.

8. The beam pumping unit of claim 1, wherein the linear drive unit is connected to the walking beam between the Sampson post and the horsehead.

9. The beam pumping unit of claim 1, wherein the Sampson post is connected to the walking beam between the linear drive unit and the horsehead.

10. A beam pumping unit configured to raise and lower a polished rod, the beam pumping unit comprising:
a base;
a Sampson post supported by the base;
a walking beam pivotably supported by the Sampson post;
a horsehead on the front end of the walking beam, wherein the horsehead is connected to the polished rod; and
a linear drive unit connected between the base and the walking beam, wherein the linear drive unit comprises a linear drive system that includes:
a ram; and
an upper pivot bearing connected between the ram and the walking beam.

11. The beam pumping unit of claim 10, wherein the linear drive unit further comprises a lower pivot bearing connected to the base.

12. The beam pumping unit of claim 10, wherein the linear drive system further comprises:
a motor;
a threaded shaft selectively rotated by the motor; and
a planetary roller nut connected to the ram and to the threaded shaft such that rotation of the threaded shaft causes the planetary roller nut and ram to move axially.

13. The beam pumping unit of claim 12, wherein the linear drive system further comprises a guide tube and wherein the ram reciprocates within the guide tube.

14. The beam pumping unit of claim 10, wherein the linear drive unit further comprises a pneumatic counterbalance system.

15. The beam pumping unit of claim 14, wherein the pneumatic counterbalance system comprises:
a pressure jacket; and
a path of communication between the interior of the ram and the pressure jacket.

16. The beam pumping unit of claim 15, wherein the counterbalance system further comprises a compressor connected to the pressure jacket that maintains the pressure of the fluid within the pressure jacket.

17. The beam pumping unit of claim 16, wherein the motor of the linear drive system further comprises:
an encoder that is configured to measure the rotational speed and position of the threaded shaft and output representative measurement signals; and
a variable speed drive that controls the operational parameters of the motor, wherein the variable speed drive includes a servo controller that adjusts the operation of the motor in response to measurements signals sent from the encoder to the servo controller.

18. The beam pumping unit of claim 10, wherein the Sampson post is connected to the walking beam between the linear drive unit and the horsehead.

19. A beam pumping unit configured to raise and lower a polished rod, the beam pumping unit comprising:
a base;
a Sampson post supported by the base, wherein the Sampson post includes a rear bearing assembly;
a walking beam supported by the Sampson post at the rear bearing assembly;
a horsehead on the front end of the walking beam, wherein the horsehead is connected to the polished rod; and
a linear drive unit supported by the base and connected to a point on the walking beam between the horsehead and the rear bearing assembly, wherein the linear drive unit comprises:
a linear drive system, wherein the linear drive system comprises:
a motor;
a threaded shaft controllably rotated by the motor;
a ram; and
a planetary roller nut connected to the ram and to the threaded shaft such that rotation of the threaded shaft causes the planetary roller nut and ram to move axially; and
a pneumatic counterbalance system, wherein the pneumatic counterbalance system applies a pneumatic pressure to the ram to offset a portion of the weight of the polished rod.

20. The beam pumping unit of claim 19, wherein the pneumatic counterbalance system comprises:
a pressure jacket;
a path of communication between the pressure jacket and the ram; and
a compressor connected to the pressure jacket that adjusts the pressure within the pressure jacket.
